(19) United States
(12) Patent Application Publication
(10) Pub. No.: US 2025/0096297 A1
(43) Pub. Date: Mar. 20, 2025

(54) NOVEL AQUEOUS-PHASE REDOX FLOW BATTERIES

(71) Applicants: KEMIWATT, RENNES (FR); UNIVERSITE DE RENNES, RENNES CEDEX (FR); CENTRALE LILLE INSTITUT, VILLENEUVE D'ASCQ (FR); CENTRE NATIONAL DE LA RECHERCHE SCIENTIFIQUE, PARIS (FR)

(72) Inventors: Thibault GODET-BAR, THORIGNE-FOUILLARD (FR); Guillaume OZOUF, Orgères (FR); Didier FLONER, SERVON SUR VILAINE (FR); Florence GENESTE, CESSON-SEVIGNE (FR); Solène GUIHENEUF, NOYAL SUR VILAINE (FR); Jean-Marie FONTMORIN, RENNES (FR); Jean-Marie AUBRY, OIGNIES (FR); Véronique RATAJ, Pont à Marcq (FR); Raphael LEBEUF, LILLE (FR); Théophile GAUDIN, ELY (GB)

(21) Appl. No.: 18/832,826

(22) PCT Filed: Jan. 27, 2023
(86) PCT No.: PCT/EP2023/052030

§ 371 Date: Jul. 24, 2024

(30) Foreign Application Priority Data
Jan. 27, 2022 (FR) FR2200707

(51) Int. Cl. H01M 8/18

(52) U.S. Cl. CPC H01M 8/188

(57) ABSTRACT

The present invention relates to a redox flow battery comprising:
a first compartment comprising a negolyte in the form of an aqueous composition comprising at least one compound of formula (I)

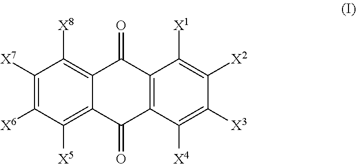

and/or a salt of the compound of formula (I),
and/or a reduced form of the compound of formula (I),
wherein X¹, X², X³, X⁴, X⁵, X⁶, X⁷ and X⁸ are independently chosen from the group consisting of a hydrogen atom, a halogen, an ether group of formula —O-A, an OH group, COOH group, -A-COOH group, —O-A-COOH group and a linear, cyclic, or branched, saturated or unsaturated hydrocarbon group comprising from 1 to 10 carbon atoms,
A representing a linear, cyclic or branched, saturated or unsaturated hydrocarbon group comprising 1 to 10 carbon atoms,
wherein at least one of X¹, X², X³, X⁴, X⁵, X⁶, X⁷ and X⁸ comprises an OH or COOH functional group;
   a second compartment comprising a posolyte in the form of an aqueous composition, comprising at least one electroactive molecule for example ferrocyanide ions [Fe(CN)₆]⁴⁻ and/or ferricyanide ions [Fe(CN)₆]³⁻,
the negolyte additionally comprising at least one solubilising base, the solubilising base being characterised in that the pKa of the conjugate acid of the solubilising base is higher than 9.5 in water at 25° C. and in that the volume of the cation of the solubilising base is between 14 and 650 cubic Angstroms.

The present invention relates to the field of aqueous-phase redox flow batteries. This invention concerns a redox flow battery comprising a negolyte comprising one or more specific additives. The present disclosure also concerns an electricity storage method with said redox flow battery.

### PRIOR ART

A Redox Flow Battery is a system using liquids (called electrolytes) to store energy. Redox flow batteries store and release electricity via reduction-oxidation reaction. In general they have two compartments in which the current collectors (electrodes) are inserted, separated by an ion exchange membrane.

At the current time, several alternatives concerning the type of redox compounds (or electroactive molecules) of the electrolyte have been developed, comprising the use of organic, organometallic redox compounds, coordination or inorganic complexes. In particular, a certain number of compounds based on an anthraquinone core have been used as electroactive molecules in aqueous electrolytes. However, the solubilities in basic aqueous phase (pH>7) of some anthraquinones, in particular those of easiest access on the market and hence attractively priced, are not sufficiently high (anthraquinones typically have an aqueous phase solubility much lower than 0.5 mol/L). On this account, electrolytes containing said anthraquinones are economically not competitive. The limited solubility of anthraquinones causes the following issues:
Clogging of the electrodes and/or of the fluid circuit i.e. depending on their state of charge, the solubility of anthraquinones can decrease and lead to precipitation. The electrodes of the battery retain these precipitates in their porous structure which increases head losses undergone by the fluid, drastically reducing the flow rate thereof within the cell and leading to collapse of battery performance.
Low system yield: low available solubility in all states of charge of the anthraquinone electroactive molecules leads to use thereof in low concentrations to prevent any problem of solid species formation, which limits the amount of available energy in the battery.
Too high cost of the system, since limiting of battery performance leads to increased overall costs. The low concentration of electroactive molecules must be offset by an increase in reactor volume, and reduced accessible capacity must be offset by an increase in the quantity of electroactive molecules. In addition, the decrease in electrolyte concentration reduces usable rated power density, which increases kW cost.

In WO2021123334, it was shown by Kemiwatt that the use of electroactive molecules based on an anthraquinone core carrying certain water-solubilising substituents allows the solubility thereof to be increased, and hence the obtaining of redox flow batteries exhibiting excellent performance. However, these molecules remain more costly than some anthraquinones commercially available on industrial level.

Additionally, the electrolytes of redox flow batteries, in addition to the electroactive molecules, may comprise one or more additives. In this case, the additive(s) must be compatible with the ion exchange membrane of the battery, failing which the result can be polluting of the membrane, increased battery resistance, reduced accessible capacity and energy yield. Also the additive(s) must be compatible with the electroactive molecules of each electrolyte (posolyte and negolyte). Incompatibility translates for example as an interaction of the additive with the electroactive molecule causing an increase in the viscosity of the fluid, a decrease in the diffusion coefficient of the charged and/or discharged species, or a reduction in electron transfer rate constants, or quite simply reduced solubility or chemical degradation of the electroactive molecule.

### Objectives of the Invention

It is one objective of the present disclosure to solve the technical problem of providing an aqueous-phase redox flow battery having high performance, in particular in terms of accessible capacity.

It is one particular objective of the present disclosure to solve the technical problem of providing a redox flow battery wherein the electroactive molecule of the negolyte has very high aqueous-phase solubility.

It is one particular objective of the present disclosure to solve the technical problem of providing a redox flow battery wherein the negolyte comprises an electroactive molecule based on an anthraquinone structure having very high aqueous-phase solubility, in particular for anthraquinone-based electroactive molecules that are easily accessible and low cost.

A further objective of the present disclosure is to solve the technical problem of providing a redox flow battery wherein the negolyte and/or posolyte comprises at least one additive compatible with the ion exchange membrane and with the electroactive molecule(s) of the negolyte, and optionally with those of the posolyte if required.

The complexity of these technical problems is particularly related to the task of solving all these problems as a whole, which the present invention sets out to achieve.

The present invention has the purpose of solving all these technical problems in reliable manner and at an economically viable industrial cost.

### DETAILED DESCRIPTION OF THE INVENTION

The present invention allows the solving of one and preferably of all the technical problems raised herein.

Therefore, the present invention concerns a redox flow battery comprising:
a first compartment comprising a negolyte, in the form of an aqueous composition, comprising at least one compound of formula (I)

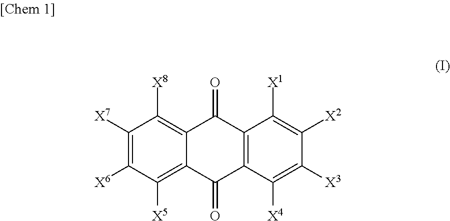

and/or a salt of the compound of formula (I),
and/or a reduced form of the compound of formula (I),
wherein X¹, X², X³, X⁴, X⁵, X⁶, X⁷ et X⁸ are each independently selected from the group formed by a hydrogen atom, a halogen, an ether group of formula-O-A, an OH group, COOH group, -A-COOH group, —O-A-COOH group, and a saturated or unsaturated, linear cyclic or branched hydrocarbon group having 1 to 10 carbon atoms,
A representing a saturated or unsaturated, linear cyclic or branched hydrocarbon group having 1 to 10 carbon atoms,
wherein at least one of X¹, X², X³, X⁴, X⁵, X⁶, X⁷ and X⁸ comprises an OH function, COOH function, or A-COOH group,
   a second compartment comprising a posolyte, in the form of an aqueous composition, comprising at least one electroactive molecule, for example ferrocyanide ions [Fe(CN)₆]⁴⁻ and/or ferricyanide ions [Fe(CN)₆]³⁻,
the negolyte additionally comprising at least one solubilising base, the solubilising base being characterised in that the pKa of the conjugate acid of the solubilising base is higher than 9.5 in water at 25° C., and in that the volume of the cation of the solubilising base is between 14 and 650 cubic Angstroms.

By electroactive molecule, it is meant an organic or organometallic molecule belonging to a redox couple, and indifferently designates either the oxidant of the redox couple or the reductant of the redox couple, or the mixture of the oxidant and reductant of the redox couple, each thereof able to be in neutral form or in the form of an ion.

By posolyte it is designated the electrolyte of the cathode compartment of the redox flow battery, and by negolyte the electrolyte of the anode compartment of the redox flow battery.

### Solubilising Base

The solubilising base allows an increase in the solubility of the compound of formula (I), and in particular the deprotonated form(s) thereof.

The solubilising base is part of an acid/base pair. When the solubilising base captures a proton, it becomes the conjugate acid thereof.

The pKa of the conjugate acid of the solubilising base corresponds to −log₁₀(Kₐ), Kₐ being the equilibrium constant of the dissociation reaction of the conjugate acid. The pKa of the conjugate acid of the solubilising base is such as described in the literature (Chimie Analytique Générale Vol1 Solutions aqueuses et non aqueuses. G. Charlot. Editions Masson (1967)) or such as predicted by COSMO-RS software (details of the method are described in the article «Accurate prediction of basicity in aqueous solution with COSMO-RS», F Eckert, A Klamt—Journal of computational chemistry, 2006-Vol 27 Pages 11-19).

The solubilising base can either be in the form of a salt associating a cation and an anion, or in the form of a neutral molecule. If the solubilising base is in the form of a salt, the cation of the solubilising base corresponds to the cation of the salt. If the solubilising base is in the form of a neutral molecule, the cation of the solubilising base corresponds to the positively charged molecule obtained after protonation of the solubilising base.

The volumes of the cations of the solubilising bases are derived from the literature for alkaline cations (Revised effective ionic radii in halides and chalcogenides” R. D. Shannon, Acta Crystallogr A (1976) 32, 751-767), or calculated with the COSMOtherm programme for organic cations (method described in the work: «From Quantum Chemistry to Fluid Phase thermodynamics and drug design», Author: Andreas Klamt (2005), Publisher: Elsevier).

Preferably, the volume of the cation of the solubilising base is between 14 and 420 cubic Angstroms, preferably between 14 and 250 cubic Angstroms.

Preferably, the solubilising base is chosen from the group formed by caesium or rubidium hydroxides, caesium or rubidium hydrogen carbonates, caesium or rubidium carbonates, and organic bases having a molar mass of between 58 and 400 grams par mole, the organic base not comprising an OH group at terminal position.

By organic base, it is meant an organic compound acting as base. The organic base can be in the form of a neutral molecule or a salt, preferably hydroxide, of an organic cation.

An organic base is composed of carbon and hydrogen atoms, nitrogen or phosphorus atoms, and optionally of oxygen and sulfur atoms.

By OH group at terminal position, it is meant an OH group carried by a primary carbon atom, i.e. bonded to only one other carbon atom, which corresponds to a primary alcohol function. For example, choline hydroxide is an organic base comprising an OH group at terminal position.

Preferably, the solubilising base is not a halide salt, the halide being chosen from among F⁻, Cl⁻, Br⁻ and I⁻.

Preferably, the solubilising base is not a secondary amine. By secondary amine, it is meant a compound of formula NHRR′, with R and R′ differing from H. For example, R and R′ can be linear or branched optionally substituted alkyl groups, and optionally comprising one or more unsaturations, or together forming an optionally substituted hydrocarbon ring and optionally comprising one or more unsaturations.

Preferably, the solubilising base is chosen from the group composed of:
caesium or rubidium hydroxides,
caesium or rubidium hydrogen carbonates,
caesium or rubidium carbonates,
hydroxides of quaternary phosphoniums [R₁R₂R₃R₄P]⁺OH⁻,
wherein R₁, R₂, R₃ et R₄, are independently chosen from among the phenyl group, —(CH₂)ₙ— Ph phenylalkyls with n being an integer of 1 to 5, linear, branched or cyclic C1-C16 alkyl chains, preferably C1-C6, optionally interrupted by at least one heteroatom chosen from among N, O and S, but not comprising an OH group at terminal position;
   hydroxides of quaternary ammoniums [R₅R₆R₇R₈N]⁺OH⁻
wherein:
either R₅, R₆, R₇ and R₈ are independently chosen from the phenyl group, —(CH₂)ₙ-Ph phenylalkyls with n being an integer of 1 to 5, and linear, branched or cyclic C1-C16 alkyl chains, preferably C1-C6, optionally interrupted by at least one heteroatom chosen from among N, O and S, but not comprising an OH group at terminal position; or R₅ is chosen from among linear, branched or cyclic C4-C20 alkyl chains, preferably C8-C20, advantageously C12-C20, optionally interrupted by at least one heteroatom chosen from among N, O and S, but not comprising an OH group at terminal position, and R₆, R₇ and R₈, are independently chosen from among linear or branched C1-C3 alkyl chains, optionally interrupted by at least one heteroatom chosen from among N, O and S, but not comprising an OH group at terminal position advantageously R₆, R₇ and R₈ are methyl groups;
or R₅ and R₆ are chosen from among linear, branched or cyclic C4-C20 alkyl chains, preferably C8-C20, advantageously C12-C20, optionally interrupted by at least one heteroatom chosen from among N, O and S, but not comprising an OH group at terminal position, and R₇ and R₈ are independently chosen from among linear or branched C1-C3 alkyl chains, optionally interrupted by at least one heteroatom chosen from among N, O and S, but not comprising an OH group at terminal position, advantageously R₇ and R₈ are methyl groups;
or R₅ and R₆ form a saturated alkyl ring having 4 to 6 carbon atoms, and R₇ and R₈ are chosen from among linear or branched C1-C6 alkyl chains, preferably C1-C3, optionally interrupted by at least one heteroatom chosen from among N, O and S, but not comprising an OH group at terminal position, advantageously R₇ and R₈ are methyl groups; or R₅, R₆ₐnd R₇ form an aromatic ring having 5 carbon atoms, and R₈ is chosen from among linear or branched C1-C6 alkyl chains, preferably C1-C3, optionally interrupted by at least one heteroatom chosen from among N, O and S, but not comprising an OH group at terminal position, advantageously R₈ is a methyl group;
   tertiary amines [R₉R₁₀R₁₁N],
wherein either R₉, R₁₀ and R₁₁ are each independently chosen from among linear, branched or cyclic C1-C8 alkyl chains, preferably C1-C4, advantageously C1-C3, optionally interrupted by at least one heteroatom chosen from among N, O and S, but not comprising an OH group at terminal position;
or R₉ and R₁₀ form a saturated alkyl ring having 4 to 6 atoms, and R₁₁ is chosen from among linear or branched C1-C8 alkyl chains, preferably C1-C4, more preferably C1-C3, optionally interrupted by at least one heteroatom chosen from among N, O and S, but not comprising an OH group at terminal position, advantageously R₁₁ is an ethyl or methyl group;
   amidines [RₐR_{b}N_{c}(R_{c})═NR_{d}]
wherein either Rₐ, R_{b}, Rₑ and R_{d}, are independently chosen from among linear branched or cyclic C1-C8 alkyl chains, preferably C1-C4, optionally interrupted by at least one heteroatom chosen from among N, O and S, but not comprising an OH group at terminal position;
or Rₐ and R_{d} form a saturated alkyl ring having 2 to 4 carbon atoms, and R_{b} and R_{c} form a saturated alkyl ring having 3 to 5 carbon atoms, each ring optionally being substituted by a linear or branched C1-C8 alkyl group, preferably C1-C4, advantageously C1-C3; and
   guanidines [RₑR_{f}N_{c}(NR_{g}Rₕ)═NH]
wherein Rₑ, R_{f}, R_{g} and Rₕ, are independently chosen from among linear branched or cyclic C1-C8 alkyl chains, preferably C1-C4, optionally interrupted by at least one heteroatom chosen from among N, O and S, but not comprising an OH group at terminal position.

In one embodiment, R₁, R₂, R₃ et R₄ are the same.

In one embodiment, the quaternary phosphonium hydroxide is tetrabutyl phosphonium hydroxide.

In one embodiment, the hydroxides of quaternary ammoniums [R₅R₆R₇R₈N]⁺OH are such that:
either R₅, R₆, R₇ and R₈ are chosen from among linear or branched C1-C6 alkyl chains, preferably C1-C3, optionally interrupted by at least one heteroatom chosen from among N, O and S, but not comprising an OH group at terminal position, advantageously R₅, R₆, R₇ and R₈ are methyl groups;
or R₅, R₆ and R₇ are chosen from among linear or branched C1-C6 alkyl chains, preferably C1-C3, optionally interrupted by at least one heteroatom chosen from among N, O and S, but not comprising an OH group at terminal position, and Rₐ is chosen from the among the phenyl group, —(CH₂)ₙ-Ph phenylalkyls with n being an integer of 1 to 5, and C8-C20 alkyl chains;
or R₅ is chosen from among linear C4-C20 alkyl chains, preferably C8-C20, advantageously C12-C20, optionally interrupted by at least one heteroatom chosen from among N, O and S, but not comprising an OH group at terminal position, and R₆, R₇ and R₈, are independently chosen from among linear C1-C3 alkyl chains, optionally interrupted by at least one heteroatom chosen from among N, O and S, but not comprising an OH group at terminal position, advantageously R₆, R₇ and R₈ are methyl groups;
or R₅ and R₆ form a saturated alkyl ring having 4 to 6 carbon atoms, and R₇ and R₈ are chosen from among linear or branched C1-C6 alkyl chains, preferably C1-C3, optionally interrupted by at least one heteroatom chosen from among N, O and S, but not comprising an OH group at terminal position, advantageously R₇ and R₈ are methyl groups;
or R₅, R₆ and R₇ form an aromatic ring having 5 carbon atoms, and Rₐ is chosen from among linear or branched C1-C6 alkyl chains, preferably C1-C3, optionally interrupted by at least one heteroatom chosen from among N, O and S, but not comprising an OH group at terminal position, advantageously Rₐ is a methyl group.

In one embodiment, R₅, R₆, R₇ and R₈ are independently chosen from among the phenyl group, —(CH₂)ₙ-Ph phenylalkyls with n being an integer of 1 to 5, preferably n=1, and linear or branched C1-C6 alkyl chains, preferably C1-C3, optionally interrupted by at least one heteroatom chosen from among N, O and S, but not comprising an OH group at terminal position.

In one embodiment, either R₅, R₆, R₇ and R₈ are the same and are chosen from among linear or branched C1-C6 alkyl chains, preferably C1-C3, preferably linear, optionally interrupted by at least one heteroatom chosen from among N, O and S, but not comprising an OH group at terminal position, or R₅ is chosen from among —(CH₂)ₙ-Ph phenylalkyls with n being an integer of 1 to 5, preferably n=1, and R₆, R₇ and R₈ are independently chosen from among linear or branched C1-C6 alkyl chains, preferably C1-C3, optionally interrupted by at least one heteroatom chosen from among N, O and S, but not comprising an OH group at terminal position, advantageously R₆, R₇ and R₈ are methyl groups.

In one embodiment, the hydroxides of quaternary ammoniums [R₅R₆R₇R₈N]⁺OH are chosen from the group formed by tetramethylammonium hydroxide, tetraethylammonium hydroxide, tetrapropylammonium hydroxide, tetrabutylammonium hydroxide, trimethyl benzylammonium hydroxide, trimethyl cetylammonium hydroxide, didodecyldimethylammonium hydroxide, trimethyl phenylammonium hydroxide, N-methylpyridinium hydroxide, dimethylpyrrolidinium hydroxide and dimethylpiperidinium hydroxide.

In one embodiment, R₅, R₆, R₇ and R₈ are the same and are chosen from among linear or branched C1-C6 alkyl chains, preferably C1-C3, preferably linear, optionally interrupted by at least one heteroatom chosen from among N, O and S, but not comprising an OH group at terminal position, advantageously R₅, R₆, R₇ and R₈ are methyl groups.

Preferably, the quaternary ammonium hydroxide [R₅R₆R₇R₈N]⁺OH⁻ is tetramethylammonium hydroxide or trimethyl benzylammonium hydroxide.

In one embodiment, the tertiary amines[R₉R₁₀R₁₁N] are such that:
either R₉, R₁₀ and R₁₁ are the same and chosen from among linear or branched C1-C8 alkyl chains, preferably C1-C4, advantageously C1-C3, preferably linear, optionally interrupted by at least one heteroatom chosen from among N, O and S, but not comprising an OH group at terminal position;
or R₉ and R₁₀ form a saturated alkyl ring having 4 to 6 atoms, and R₁₁ is chosen from among linear or branched C1-C8 alkyl chains, optionally interrupted by at least one heteroatom chosen from among N, O and S, but not comprising an OH group at terminal position, advantageously R₁₁ is an ethyl or methyl group.

In one embodiment, the tertiary amines [R₉R₁₀R₁₁N] are chosen from the group composed of trimethylamine, triethylamine, ethyldimethylamine, diethylmethylamine, N-methylpyrrolidine, N-ethylpyrrolidine, N-methylpiperidine and N-ethylpiperidine. Preferably, the tertiary amines [R₉R₁₀R₁₁N] are chosen from the group composed of trimethylamine, triethylamine and N-methylpyrrolidine.

In one embodiment, the amidines [RₐR_{b}NC(Rr)=NR_{d}] are such that Rₐ and R_{d} form a saturated alkyl ring having 2 to 4 carbon atoms, and R_{b} and R_{c} form a saturated alkyl ring having 3 to 5 carbon atoms, each ring optionally being substituted by a linear or branched C1-C8 alkyl group, preferably C1-C4, advantageously C1-C3.

In one embodiment, the amidine [RₐR_{b}NC(R_{c})═NR_{d}] is 1,8-diazabicyclo[5.4.0]undec-7-ene.

In one embodiment, Rₑ, R_{f}, R_{g} and Rₕ, are the same.

In one embodiment, the guanidine [RₑR_{f}NC(NR_{g}Rₕ)═NH] is 1,1,3,3-tetramethylguanidine.

The different embodiments concerning the type of different families of solubilising base (caesium or rubidium hydroxides, caesium or rubidium hydrogen carbonates, caesium or rubidium carbonates, quaternary phosphonium hydroxides [R₁R₂R₃R₄P]⁺OH⁻, quaternary ammonium hydroxides [R₅R₆R₇R₈N]⁺OH⁻, tertiary amines [R₉R₁₀R₁₁N], amidines [RₐR_{b}NC(R_{c})═NR_{d}] and guanidines [RₑR_{f}NC(NR_{g}Rₕ)═NH]) are independent and combinable with each other.

Preferably, the solubilising base is chosen from the group formed by CsOH, RbOH, trimethylamine, triethylamine, ethyldimethylamine, diethylmethylamine, N-methylpyrrolidine, N-ethylpyrrolidine, N-methylpiperidine, N-ethylpiperidine, 1,8-diazabicyclo[5.4.0]undec-7-ene, 1,1,3,3-tetramethylguanidine, tetramethylammonium hydroxide, tetraethylammonium hydroxide, tetrapropylammonium hydroxide, tetrabutylammonium hydroxide, trimethyl benzylammonium hydroxide, trimethyl cetylammonium hydroxide, didodecyldimethylammonium hydroxide, trimethyl phenylammonium hydroxide, N-methylpyridinium hydroxide, N,N-dimethylpyrrolidinium hydroxide, N,N-dimethylpiperidinium hydroxide and tetrabutylphosphonium hydroxide.

Preferably, the solubilising base is chosen from the group composed of CsOH, RbOH, trimethylamine, triethylamine, N-methylpyrrolidine, 1,1,3,3-tetramethylguanidine, tetramethylammonium hydroxide, tetrabutylammonium hydroxide, trimethyl benzylammonium hydroxide and tetrabutylphosphonium hydroxide.

### Negolyte

The negolyte of the redox flow battery of the invention comprises at least one solubilising base.

Preferably, the solubilising base has a molar concentration in the negolyte of between 0.1 mol/L and 5.0 mol/L, preferably between 0.2 mol/L and 4.0 mol/L, more preferably between 0.3 mol/L and 3.0 mol/L, advantageously between 0.4 mol/L and 2.5 mol/L.

When the negolyte comprises several solubilising bases (at least two), the total molar concentration of all the solubilising bases is between 0.1 mol/L and 5.0 mol/L, preferably between 0.2 mol/L and 4.0 mol/L, more preferably between 0.3 mol/L and 3.0 mol/L, advantageously between 0.4 mol/L and 2.5 mol/L.

In one embodiment, the negolyte is free of Cl⁻ and Br ions and preferably is free of halide ions, the halide ion being chosen from among F⁻, Cl⁻, Br⁻ and I⁻. In one embodiment, the negolyte further comprises a secondary base chosen from among potassium hydroxide, sodium hydroxide, lithium hydroxide, ammonium hydroxide, preferably from among potassium hydroxide, sodium hydroxide and lithium hydroxide.

The cation of the secondary base is therefore a cation chosen from among K⁺, Na⁺, Li⁺ and NH₄⁺, preferably among K⁺, Na⁺ and Li⁺.

The role of the secondary base is to increase the conductivity and pH of the negolyte; additionally it allows the contributing of cations which diffuse through the membrane at a suitable rate for the application.

The secondary base of the invention does not comprise a divalent cation such as Mg²⁺. The presence of a divalent cation could lower the solubility of the formula (I) compound in the negolyte.

Preferably, the secondary base has a molar concentration in the negolyte of between 0.01 mol/L and 5.0 mol/L, preferably between 0.2 mol/L and 4.0 mol/L, more preferably between 0.3 mol/L and 3.0 mol/L, advantageously between 0.4 mol/L and 2.5 mol/L.

In the negolyte, [M_{solub,nego}] corresponds to the molar concentration in the negolyte of solubilising base cations as defined in the invention, and [M_{′second,nego}] corresponds to the molar concentration in the negolyte of secondary base cations. Preferably, the ratio between [M_{solub,nego}] and [M_{′second,nego}] is higher than or equal to 0.1, preferably higher than or equal to 0.3, more preferably higher than or equal to 0.6 and lower than or equal to 10, advantageously higher than or equal to 0.8 and lower than or equal to 3.

This allows the applicability of the battery to be improved, in particular when used under real conditions.

The negolyte of the redox flow battery of the invention additionally comprises at least one compound of formula (I).

Preferably, the molar concentration of the formula (I) compound in the negolyte is between 0.1 mol/L and 2 mol/L, preferably between 0.2 mol/L and 1.0 mol/L, more preferably between 0.25 mol/L and 0.8 mol/L, advantageously between 0.3 mol/L and 0.6 mol/L.

By halogen, it is meant the atoms F, Cl, Br and I.

In one embodiment, the redox flow battery of the invention may comprise a mixture of at least two formula (I) compounds differing from each other.

Preferably, X¹, X², X³, X⁴, X⁵, X⁶, X⁷ and X⁸ are independently chosen from the group formed by a hydrogen atom, a halogen, an ether group of formula —O-A, an OH group, COOH group, -A-COOH group, —O-A-COOH group and a saturated, linear or branched hydrocarbon group having 1 to 10 carbon atoms, preferably 1 to 8 carbon atoms, more preferably 1 to 6 carbon atoms, advantageously 1 to 4 carbon atoms, and A representing a saturated linear or branched hydrocarbon group having 1 to 10 carbon atoms, preferably 1 to 8 carbon atoms, more preferably 1 to 6 carbon atoms, advantageously 1 to 4 carbon atoms.

In one embodiment, X¹, X², X³, X⁴, X⁵, X⁶, X⁷ and X⁸ of the formula (I) compound are independently chosen from the group formed by a hydrogen atom, an OH group, COOH group, (CH₂)ₙ—COOH group where n is an integer varying from 1 to 10, and a saturated or unsaturated, linear, cyclic or branched hydrocarbon group having 1 to 10 carbon atoms.

Preferably, the formula (I) compound is chosen from the group composed of:

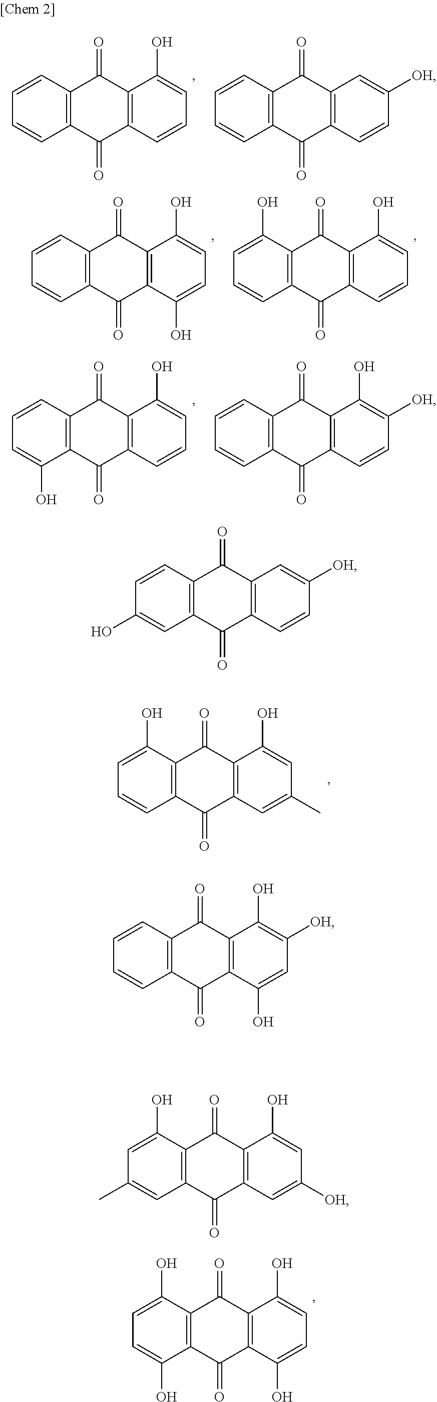

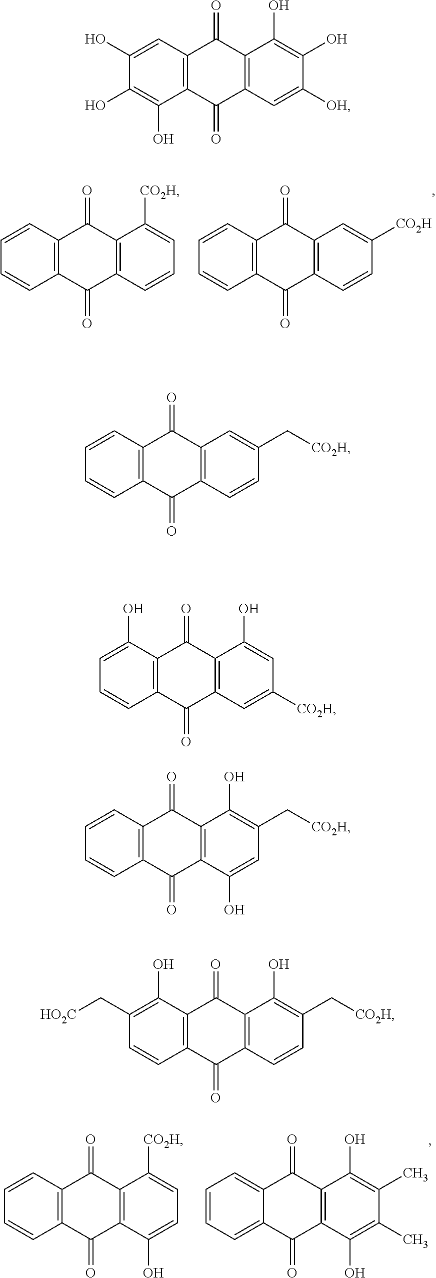

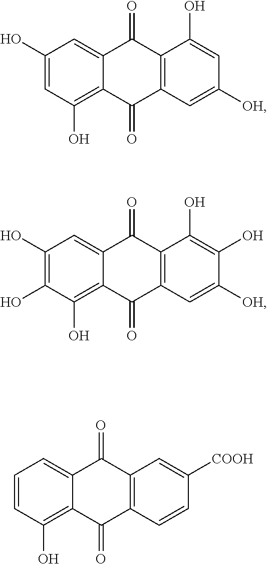 [SMILES: O=C1c2cc(O)cc(O)c2C(=O)c2cc(O)cc(O)c21 ; O=C1c2cc(O)c(O)c(O)c2C(=O)c2cc(O)c(O)c(O)c21 ; O=C(O)c1ccc2c(c1)C(=O)c1cccc(O)c1C2=O]

Preferably, the formula (I) compound is chosen from the group formed by quinizarin (1,4-DHAQ), chrysazin (1,8-DHAQ), anthrarufin (1,5-DHAQ), alizarin (1,2-DHAQ), anthraflavic acid (2,6-DHAQ) and cassic acid (1,8-DHAQ-3-COOH).

In another embodiment, in the formula (I) compound of the invention, X³═H, one and only one of X¹, X², X⁴, X⁵, X⁶, X⁷ and X⁸ is OH, and one and only one of X¹, X², X⁴, X⁵, X⁶, X⁷ and X⁸ is —O-A-COOH.

Preferably, A is (CH₂)ₙ, optionally substituted, where n is an integer chosen from 1 to 10, preferably 2 to 5, and more preferably it is 3 or 4.

Preferably, in the formula (I) compound of the invention,
X¹═—O-A-COOH and X²═OH, or
X¹═OH and X²═O-A-COOH, or
X¹═—O-A-COOH and X⁴═OH, or
X¹═—O-A-COOH and X⁵═OH, or
X²═—O-A-COOH and X⁶═OH, or
X²═—O-A-COOH and X⁷═OH, or
X═—O-A-COOH and X⁸═OH.

Preferably, in the formula (I) compound of the invention, X¹, X², X⁴, X⁵, X⁶, X⁷ and X⁸ are independently chosen from the group formed by a hydrogen atom, an OH group and —O-A-COOH group, wherein one and only one of X², X⁴, X⁵, X⁶, X⁷ and X⁸ is OH, and wherein one and only one of X¹, X², X⁴, X⁵, X⁶, X⁷ and X⁸ is —O-A-COOH.

Preferably, in the formula (I) compound of the invention, X¹═OH and X⁴═—O-A-COOH, more preferably X¹═OH and X⁴═—O—(CH₂)₃—COOH. Further preferably, X¹═OH, X⁴═—O-A-R¹ and X²═X⁵=X⁶═X⁷=X⁸═H. Advantageously X¹═OH, X⁴═—O—(CH₂)₃-COOH and X²═X⁵=X⁶═X⁷=X⁸═H.

In one embodiment, the negolyte is composed of one or more solubilising bases, one or more formula (I) compounds, and optionally one or more secondary bases such as defined in the present invention. All the embodiments and preferred characteristics defined above for the negolyte are applicable.

### Posolyte

The posolyte comprises at least one electroactive molecule.

Preferably, the molar concentration of the electroactive molecule in the posolyte is between 0.1 mol/L and 4 mol/L, preferably between 0.4 mol/L and 2 mol/L, more preferably between 0.5 mol/L and 1.6 mol/L, advantageously between 0.6 mol/L and 1.2 mol/L.

Among electroactive molecules, mention can be made of the ferrocyanide ion and/or ferricyanide ion, ferrocene and/or ferrocenium ions, the ferrocene and ferrocenium ion optionally being substituted by at least one group -A-Z₁ or group —O-A-Z₁, A being a saturated or unsaturated, linear, cyclic or branched hydrocarbon group having 1 to 10 carbon atoms and Z₁ being —CO₂H, —PO₃H; —PO₄H; —SO₃H or —SO₄.

Preferably, the electroactive molecule of the posolyte is the ferrocyanide ion and/or ferricyanide ion. The ferrocyanide ion is added to the posolyte in the form of a salt, preferably a potassium, lithium, sodium or ammonium salt, advantageously in the form of a potassium salt.

The posolyte may additionally comprise at least one base chosen from among the solubilising bases and secondary bases as defined in the present invention.

Preferably, the base has a molar concentration in the posolyte of between 0.01 mol/L and 1.00 mol/L preferably between 0.01 mol/L and 0.60 mol/L, more preferably between 0.01 mol/L and 0.40 mol/L, advantageously between 0.01 mol/L and 0.20 mol/L.

In one embodiment, the base included in the posolyte is chosen from among the solubilising bases defined in the part of the above description concerning the solubilising base. Preferably, the solubilising base is in salt form, preferably a hydroxide salt. The solubilising base is therefore preferably formed by a cation M_{B} and an anion, preferably a cation M_{B} and a hydroxide anion, the cation M_{B} being chosen from the group formed by Cs⁺, Rb⁺, quaternary phosphoniums [R₁R₂R₃R₄P]⁺ and quaternary ammoniums [R₅R₆R₇R₈N]+, R₁, R₂, R₃, R₄, R₅, R₆, R₇ and R₈ being as defined above. In this embodiment, it can be advantageous that the electroactive molecule of the posolyte should be an anion, and therefore added in salt form of which the cation M_{ME} is chosen from the group formed by Cs⁺, Rb⁺, quaternary phosphoniums [R₁R₂R₃R₄P]⁺ and quaternary ammoniums [R₅R₆R₇R₈N]⁺, R₁, R₂, R₃, R₄, R₅, R₆, R₇ and R₈ being as defined above. In one advantageous embodiment, the cation M_{ME} of the electroactive molecule and the cation M_{B} of the solubilising base are the same. Therefore, in this embodiment, the posolyte comprises cations M, which represent all the cations M_{B} and M_{ME}. In this embodiment, the posolyte is preferably without a secondary base. In this embodiment, the posolyte is preferably free of cations K⁺, Na⁺, Li⁺ and NH₄⁺.

Preferably, the molar concentration of cations M in the posolyte is between 0.1 mol/L and 17 mol/L, preferably between 0.4 mol/L and 8.6 mol/L, more preferably between 0.5 mol/L and 6.8 mol/L, advantageously between 0.6 mol/L and 5 mol/L, the cations M being chosen from the group formed by Cs⁺, Rb⁺, quaternary phosphoniums [R₁R₂R₃R₄P]⁺ and quaternary ammoniums [R₅R₆R₇R₈N]⁺, R₁, R₂, R₃, R₄, R₅, R₆, R₇ and R₈ being as defined above.

In another embodiment, the base included in the posolyte is chosen from among the secondary bases as defined above. The base included in the posolyte is therefore preferably of formula M_{B}′OH, with M_{B}′ being chosen from the group formed by K⁺, Na⁺, Li⁺ and NH₄⁺. In this embodiment, the electroactive molecule can optionally be added in salt form of which the cation M_{ME}′ is chosen from the group formed by K⁺, Na⁺, Li⁺ and NH₄⁺. Therefore, in this embodiment, the posolyte comprises cations M′ which represent either the cations M_{B}′, or all the cations M_{B}′ and M_{ME}′.

Preferably, the molar concentration of cations M′ is between 0.1 mol/L and 17 mol/L, preferably between 0.4 mol/L and 8.6 mol/L, more preferably between 0.5 mol/L and 6.8 mol/L, advantageously between 0.6 mol/L and 5 mol/L, the cations M′ being chosen from the group formed by K⁺, Na⁺, Li⁺ and NH₄⁺.

In this embodiment, the posolyte may additionally comprise at least one solubilising base as defined in the above description. In this case, the molar concentration of solubilising base is between 0.01 mol/L and 1 mol/L, preferably between 0.01 mol/L and 0.6 mol/L, more preferably between 0.01 mol/L and 0.4 mol/L, advantageously between 0.01 mol/L and 0.2 mol/L.

In one embodiment, the posolyte is free of Cl⁻ and Br⁻ ions, preferably is free of halide ion, the halide ion being chosen from among F⁻, Cl⁻, Br⁻ and I⁻.

In another embodiment, the negolyte and the posolyte are free of Cl⁻ and Br⁻ ions, preferably are free of halide ion, the halide ion being chosen among F⁻, Cl⁻, Br⁻ and I⁻.

In one embodiment, the posolyte is composed of one or more electroactive molecules and one or more bases chosen from among the solubilising bases and secondary bases. All the embodiments and preferred characteristics defined above for the_posolyte are applicable.

### Battery

The redox flow battery of the invention further comprises a membrane, preferably an amphoteric membrane or cation exchange semi-permeable membrane, said membrane comprising a material chosen from the group formed by fluorinated (co)polymers, (co)poly (ether ketone)s, (co)poly(ether sulfone)s, (co)poly(ether-ether-ketone)s, sulfonated (co)poly(ether-ether-ketone)s, benzimidazole (co)polymers and arylene (co)polymers, preferably chosen from the group formed by sulfonated tetrafluoroethylene fluorinated copolymers, ionomers of perfluorosulfonic acid, and sulfonated (co)poly(ether-ether-ketone)s.

Preferably, the posolyte and negolyte have a temperature of between 10° C. and 50° C., more preferably between 15° C. and 45° C., advantageously between 20° C. and 40° C.

In the invention, the battery comprises a molar quantity n_{solub,batt} of cations of the solubilising base M_{solub,batt}, and optionally a molar quantity n′_{second,batt} of cations chosen from the group formed by K⁺, Na⁺, Li⁺ and NH₄⁺. The molar quantity n_{solub,batt} corresponds to the molar quantity of cations of solubilising base in the negolyte, to which is optionally added the molar quantity of cations of solubilising base in the posolyte. The molar quantity n′_{second,batt} corresponds to the molar quantity of cations, if any, chosen from the group formed by K⁺, Na⁺, Li⁺ and NH₄⁺ in the negolyte, or to the molar quantity of cations chosen from the group formed by K⁺, Na⁺, Li⁺ and NH₄⁺ in the posolyte, or to the sum of the molar quantity of cations chosen from the group formed by K⁺, Na⁺, Li⁺ and NH₄⁺ in the negolyte and posolyte.

Preferably, the ratio between n_{solub,batt} and n′_{second,batt} is higher than or equal to 0.1, preferably higher than or equal to 0.3, more preferably higher than or equal to 0.6 and lower than or equal to 10, advantageously higher than or equal to 0.8 and lower than or equal to 3.

The present invention also concerns a method for storing electricity by at least one redox flow battery, characterized in that the redox flow battery is of the invention.

The present invention also concerns a method of producing electricity by at least one redox flow battery, characterized in that the redox flow battery is of the invention.

### DESCRIPTION OF THE FIGURES

FIG. 1 is a voltammogram of alizarin (5×10⁻³ M) in 0.1 M KOH (in black) and 0.1 M CsOH (in grey). Scan rate 20 mV·s⁻¹.

FIG. 2 is a graph showing changes in discharge capacity of battery N′1 over charge and discharge cycles (50 first cycles illustrated).

FIGS. 3 and 4 are graphs showing changes in discharge capacity of battery N°2 over charge and discharge cycles (27 first cycles, and cycles 296 to 328 illustrated respectively).

FIG. 5 is a graph showing changes in discharge capacity of battery N°3 over charge and discharge cycles (120 first cycles illustrated).

FIG. 6 is a graph showing changes in discharge capacity of battery N°4 over charge and discharge cycles (10 first cycles illustrated).

FIG. 7 is a graph showing changes in energy density of batteries N°3 (black curve) and N°4 (grey curve) over charge and discharge cycles (19 first cycles illustrated).

FIG. 8 is a graph showing changes in solubility of a compound of formula (I) of the invention (alizarin) as a function of the molar ratio between the molar concentration of solubilising base and the sum of the molar concentration of solubilising base and molar concentration of secondary base (placed in equilibrium 1 day at 21° C.).

FIG. 9 is a graph showing changes in the solubility of a formula (I) compound of the invention (quinizarin) as a function of the molar ratio between the molar concentration of solubilising base and the sum of the molar concentration of solubilising base and molar concentration of secondary base (placed in equilibrium 3 days at 21° C.).

The present will now be described with the aid of nonlimiting examples.

### EXAMPLES

### Example 1: Characteristics of Solubilising Bases of the Invention and Secondary Bases

Table 1 below gives the characteristics of different examples of solubilising bases of the invention, and of secondary bases LiOH, NaOH, KOH and NH₄OH (differing from the solubilising bases). Particularly indicated are the pKa of the corresponding conjugate acid of each base, and the volume of the corresponding cation of each base.

TABLE 1

| Base | | | Formed cation | | | |
|---|---|---|---|---|---|---|
| | | MW | | | Radius/ | Volume/ |
| Name | Structure | (g/mol) | Cation | pKₐ | Å | Å³ |

Hydroxides of alkali metals

| | | | | | | |
|---|---|---|---|---|---|---|
| Lithium hydroxide | LiOH | 23.9 | Li⁺ | ≈14 | 0.76^{b} | 1.8 |
| Sodium hydroxide | NaOH | 40.0 | Na⁺ | 14 | 1.02^{b} | 4.4 |
| Potassium hydroxide | KOH | 56.1 | K⁺ | 14 | 1.38^{b} | 11.0 |
| Rubidium hydroxide | RbOH | 102.5 | Rb⁺ | 14 | 1.52^{b} | 14.7 |
| Caesium hydroxide | CsOH | 149.9 | Cs⁺ | 14 | 1.67^{b} | 19.5 |

Ammonia

| | | | | | | |
|---|---|---|---|---|---|---|
| Ammonia | NH₄OH | 35.0 | NH₄⁺ | 9.25 | 1.48^{c} | 13.6 |

Tertiary amines

| | | | | | | |
|---|---|---|---|---|---|---|
| Trimethyl | NMe₃ | 59.1 | NMe₃H⁺ | 9.8^{a} | 2.89 | 101.3^{d} |
| amine | | | | | | |
| Dimethyl, ethyl amine | NMe₂Et | 73.1 | NMe₂EtH⁺ | 10.0^{a} | 3.08 | 122.5^{d} |
| Methyl, diethyl amine | NMeEt₂ | 87.2 | NMeEt₂H⁺ | 10.3^{a} | 3.25 | 143.7^{d} |
| Triethyl | NEt₃ | 101.2 | NEt₃H⁺ | 10.6^{a} | 3.40 | 165.1^{d} |
| amine | | | | | | |
| N-Methyl pyrrolidine | 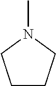 | 85.1 | 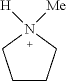 | 10.5^{a} | 3.15 | 130.5^{d} |
| N-Ethyl pyrrolidine | 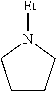 | 99.2 | 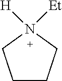 | 10.7 | 3.31 | 152.0^{d} |
| N-Methyl piperidine | 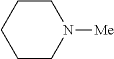 | 99.2 | 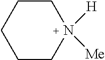 | 10.1 | 3.29 | 149.2^{d} |
| N-Ethyl piperidine | 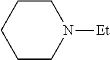 | 113.2 | 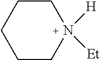 | 10.4^{a} | 3.44 | 171.0^{d} |

Amidines and guanidines

| | | | | | | |
|---|---|---|---|---|---|---|
| DBU (1,8 Diaza bicyclo[5.4.0]undec-7- ene) | 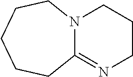 | 152.2 | 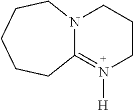 | 13.5 | 3.67 | 207.1^{d} |
| 1,1,3,3-Tetramethyl guanidine | 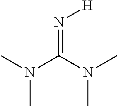 | 115.2 | 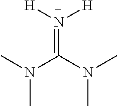 | 13.0 | 3.42 | 167.4^{d} |

Hydroxides of quaternary ammoniums and pyridiniums

| | | | | | | |
|---|---|---|---|---|---|---|
| Tetramethyl | NMe₄OH | 91.1 | NMe₄⁺ | 14 | 3.08 | 122.2^{d} |
| ammonium | | | | | | |
| Tetraethyl | NEt₄OH | 147.3 | NEt₄⁺ | 14 | 3.65 | 203.2^{d} |
| ammonium | | | | | | |
| Tetrapropyl | NPr₄OH | 203.4 | NPr₄⁺ | 14 | 4.11 | 291.4^{d} |
| ammonium | | | | | | |
| Tetrabutyl | NBu₄OH | 259.5 | NBu₄⁺ | 14 | 4.49 | 379.2^{d} |
| ammonium | | | | | | |
| Tetramethyl, benzyl ammonium | 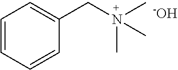 | 167.3 | 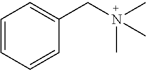 | 14 | 3.73 | 217.7^{d} |
| Trimethyl, cetyl ammonium | NMe₃CetylOH | 301.6 | 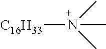 | 14 | 4.74 | 446.2^{d} |
| Didodecyl, dimethyl ammonium | NMe₂Lauryl₂OH | 399.7 | 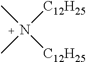 | 14 | 5.25 | 605.5^{d} |
| Trimethyl, phenyl ammonium | PhNMe₃OH | 153.2 | 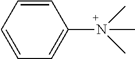 | 14 | 3.60 | 194.9^{d} |
| N-Methyl pyridinium | 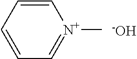 | 111.1 | 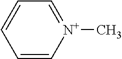 | 14 | 3.16 | 132.5^{d} |
| N,N-Dimethyl pyrrolidinium | 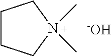 | 117.2 | 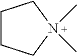 | 14 | 3.30 | 150.8^{d} |
| N,N-Dimethyl piperidinium | 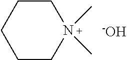 | 131.2 | 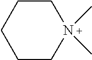 | 14 | 3.43 | 169.5^{d} |

Hydroxides of quaternary phosphoniums

| | | | | | | |
|---|---|---|---|---|---|---|
| Tetrabutyl | PBu₄OH | 276.4 | PBu₄⁺ | 14 | 4.58 | 402.4^{d} |
| phosphonium | | | | | | |

^{a}«Correlation of the Base Strengths of Amines» H. K. Hall, J. Amer. Chem. Soc (1957) 79, 5441
^{b}These ionic radii correspondent to the hexa-coordinate cations within a crystal. «Revised effective ionic radii in halides and
chalcogenides” R. D. Shannon, Acta Crystallogr A (1976) 32, 751-767
^{c}“On the effective ionic radii for ammonium” V. Sidey, Acta Crystallogr B (2016) B72, 626
^{d}The volumes of the organic cations were calculated with COSMOtherm 2021 software, and the radii thereof were calculated
from the volumes by likening the cation to a sphere.

### Example 2: Enhancing the Solubility of Formula (I) Compounds with the Presence of a Solubilising Base of the Invention

The solubility in water of some formula (I) compounds was evaluated in the presence of 1.2 mol/L of different solubilising bases, alone or in the presence of LiOH, NaOH, KOH and optionally NH₄OH (secondary base). More specifically, the purpose was to evaluate the solubility of the ion pair [deprotonated anthraquinone-cation], resulting from deprotonation of the formula (I) compounds by said bases. The table below gives the relative solubility of these formula (I) compounds compared with a reference solubility which is the solubility thereof in the presence of 1 mol/L NaOH.

TABLE 2

| | 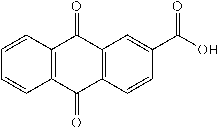 | 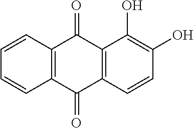 [SMILES: O=C1c2ccccc2C(=O)c2c1ccc(O)c2O] | 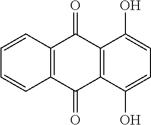 | 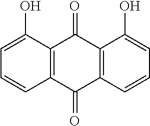 [SMILES: O=C1c2cccc(O)c2C(=O)c2c(O)cccc21] |
|---|---|---|---|---|
| Solubility in | 2.5 × 10⁻⁴ mol/L | 2.3 × 10⁻² mol/L | 3.8 × 10⁻³ mol/L | 1.8 × 10⁻³ mol/L |
| NaOH_{aq} 1 mol/L | | | | |
| NaOH | 1 (reference) | 1 (reference) | 1 (reference) | 1 (reference) |
| LiOH | ×14 | ×2 | ×0.03 | ×0.03 |
| KOH | ×10 | ×3 | ×8 | ×3 |
| RbOH | ×150 | ×19 | ×16 | ×5 |
| CsOH | ×70 | ×22 | ×32 | ×48 |
| (NH₃)_{aq} | ×50 | ×1 | ×3 | ×3 |
| NMe₃ | ×2000 | ×43 | n.d. | ×2 |
| NEt₃ | ×2000 | ×39 | ×3 | ×19 |
| N-Methyl | n.d. | ×43 | ×7 | ×6 |
| pyrrolidine | | | | |
| N-Ethyl | ×2000 | ×43 | ×13 | ×13 |
| pyrrolidine | | | | |
| NMe₄OH | ×3700 | ×40 | ×213 | ×494 |
| Trimethyl, benzyl | n.d. | ×33 | ×255 | ×418 |
| ammonium | | | | |
| PBu₄OH | ×4100 | ×23 | ×211 | ×218 |
| DBU | n.d. | n.d. | ×234 | ×88 |
| 1,1,3,3-Tetramethyl | ×4100 | ×37 | ×82 | ×500 |
| guanidine | | | | |

Fully unexpectedly, the presence of a solubilising base in an aqueous solution of different formula (1) compounds allows a spectacular increase (up to 4000 times) in the solubility of these formula (1) compounds.

### Example 3: Comparison of the Solubility in Water of Formula (I) Compounds in Negolytes of Different Compositions

The table below gives the relative solubility of quinizarin and chrysazin as a function of different compositions of negolyte, the solubility being relative to a reference solubility which is the solubility thereof in the presence of 1.1 mol/L KOH. The absolute solubilities of quinizarin and chrysazin in an aqueous solution of KOH 1 mol/L are respectively 3.1×10⁻² mol/L and 4.8×10⁻³ mol/L.

The negolytes comprising NMe₄OH (a solubilising base of the invention) and KOH are of the invention, and the negolytes comprising solely KOH or tetramethylammonium chloride are comparative (tetramethylammonium chloride is not a solubilising base of the invention. The halides of tetraalkylammonium are neither bases nor acids, and therefore do not have a pKa. Placed in solution, they do not modify the pH thereof irrespective of the amount added).

TABLE 3

| | 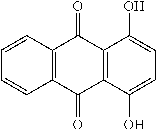 [SMILES: O=C1c2ccccc2C(=O)c2c(O)ccc(O)c21] | 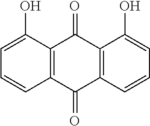 [SMILES: O=C1c2cccc(O)c2C(=O)c2c(O)cccc21] |
|---|---|---|
| KOH (1.1 mol/L) | 1 (reference) | 1 (reference) |
| KOH (1.6 mol/L) | Caking | Caking |
| NMe₄Cl | | |
| (0.75 mol/L) | | |
| KOH (1.1 mol/L) | 2 | 3 |
| NMe₄Cl | | |
| (1.1 mol/L) | | |
| KOH (0.5 mol/L) | 10 | 29 |
| NMe₄OH | | |
| (1.1 mol/L) | | |
| NMe₄OH | 12 | 83 |
| (1.1 mol/L) | | |

In the presence of tetramethylammonium chloride, quinizarin and chrysazin remain very scarcely soluble in an aqueous medium. Solely the presence of one or more solubilising bases of the invention allows a significant improvement in the solubility of these two compounds in an aqueous medium.

### Example 4 (Comparative): Solubility in Water of Different Formula (I) Compounds of the Invention

The following table gives the relative solubilities in water of anthraquinone-SO₃H below which is not a formula (I) compound of the invention.

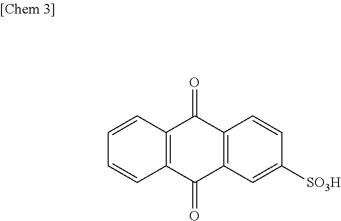 [SMILES: O=C1c2ccccc2C(=O)c2cc(S(=O)(=O)O)ccc21]

TABLE 4

| Base | Relative solubility |
|---|---|
| None (solubility of non-deprotonated | 1 |
| anthraquinone-SO₃H, | |
| reference measurement) | |
| LiOH | 0.38 |
| NaOH | 0.03 |
| KOH | 0.14 |
| CsOH | 0.38 |
| NH₄OH | 0.14 |
| NMe₄OH | 0.58 |

These results show that irrespective of the base used, even a solubilising base of the invention, the acid form of a sulfonated anthraquinone is more soluble than the deprotonated form, unlike the formula (I) compounds of the invention of which the carboxylic (R—CO₂H) and phenolic (Ar—OH) protonated forms are very scarcely soluble in water, whereas the forms deprotonated by a solubilising base of the invention are more soluble.

The AQ-SO₃H above is a strong acid of which the ion pair is particularly dissociated compared with that of anthraquinones substituted by a group OH and/or by a group COOH.

### Example 5: Study on the Compatibility of the Solubilising Bases with Different Membranes

The impact of the presence of a solubilising base in the negolyte on the performance of two membranes was evaluated by investigating the ohmic resistance of a symmetric cell, following the protocol described below.

An electrolyte comprising a 50:50 mixture of sodium ferricyanide and sodium ferrocyanide at a total concentration of 0.5 mol/L was formulated. This electrolyte was placed in the two compartments of a redox flow battery having a cell composed of the membrane to be tested. The tested membranes were two cation exchange semi-permeable membranes having two different structures: i) the first was composed of a perfluorinated backbone and perfluorosulfonated chain ensuring the ionic conduction thereof (of Nafion type, grade Solvay 50 μm,K+); ii) the second was composed of a sulfonated poly(ether-ether-ketone) backbone (of hydrocarbon type, grade Fumatech Fumasep E620K).

The so-called symmetric battery, since it is composed of two electrolytes of same formulation, has a state of charge (SOC) imposed by the proportion of the mixture: ferricyanide (charged form)/ferrocyanide (discharged form) i.e. 50%. This state of charge allows measurement of the strictly ohmic resistance of the cell by obscuring polarizing contributions i) of charge transfer activation and ii) mass transfer which occur at the start and end respectively of the charge and discharge processes of battery cycling.

A linear polarisation curve (LPC) is programmed in the form of a current ramp and the resistance value of the cell is inferred by measuring the slope obtained with the plotting of =f(U); J being the current density (mA/cm²) imposed on the cell, U being the voltage (V) measured at the cell terminals. This value is confirmed after reversible cycling of 5 cycles at a current of ±2A of which the capacity is limited to 20 mA·h (i.e. 15% of SOC) and the plotting of a new LPC. This experimental loop is repeated until the value of the area-specific resistance (ASR) of the cell is stable and therefore reliable.

0.1 mol/L of the solubilising base it is desired to investigate is dissolved in each compartment of the battery (same end pH values), and the preceding protocol is repeated to determine the resistance value corrected by the presence of the added species. This active surface resistance of the cell is compared with that of the reference, namely that obtained with 0.1 mol/L of NaOH.

The results obtained are given in the table below. The indication «Compatible» means that the active surface resistance measured with the compound under consideration is comparable with that obtained with 0.1 mol/L of NaOH to within 5%. The indication «Incompatible» means that this value exceeds the reference value by more than 5% and, in this case, it is recorded.

TABLE 5

| | Nafion type | Hydrocarbon type |
|---|---|---|
| | membrane | membrane |
| CsOH 0.1 mol/L | Compatible | Compatible |
| RbOH 0.1 mol/L | Compatible | Compatible |
| NH₄OH 0.1 mol/L | Compatible | Compatible |
| ^{t}MeNOH 0.1 mol/L | Incompatible: +70% | Compatible |
| ^{t}BuNOH 0.1 mol/L | Incompatible: >+1000% | Incompatible: >+1000% |
| TriméthylbenzylNOH | Incompatible: +852% | Incompatible: +240% |
| 0.1 mol/L | | |
| CholineOH 0.1 mol/L | Incompatible: +77% | Compatible |
| Tetraméthylguanidine | Incompatible: +330% | Compatible |
| 0.1 mol/L | | |
| Triethylamine 0.1 | Incompatible: +450% | Compatible |
| mol/L @pH = 9.5 | | |
| ^{t}BuPOH 0.1 mol/L | Incompatible: >+1000% | Compatible |

These results allow evidencing that the compatibility between the cations and the membrane is dependent upon the type of constituent backbone of this membrane.

### Example 6: Study on the Chemical Compatibility of the Solubilising Bases with the Posolyte

Ferricyanide, the oxidised form of ferrocyanide, is formed in the posolyte of the battery as soon as the state of charge (SOC) is higher than 0%. At 100% SOC, the posolyte is solely composed of ferricyanide. Under these conditions, the electrolyte acquires an oxidising nature.

If an additive is added to the battery, such as a solubilising base, it must be verified whether it is compatible with all the elements of the battery, and in particular the oxidation resistance thereof in the event of contact with the ferricyanide. This is relevant even if the addition is made to the negolyte, since it cannot be excluded that part of the additive may be transferred into the posolyte via the membrane of the battery.

To determine this compatibility, a test was conducted in a solution containing 0.5 mol/L potassium ferricyanide and 0.1 mol/L of compound to be tested, to impose a pH of about 13 (if the compound is an acid as in the case of guanidinium-HCl, 0.1 mol/L of KOH is added to adjust the pH). A conventional electrochemical test is carried out, namely linear voltammetry of −0.4 V to +0.8 V vs Ag/AgCl at 10 mV/s, using a rotating disc electrode in glassy carbon, 3 mm in diameter, rotating at 400 rpm. The characteristic half-wave obtained allows determination of the SOC of the electrolyte (the % de ferricyanide contained in solution divided by the total content of ferricyanide+ferrocyanide), by calculating the following ratio of limiting currents: (i_{l,a})/(l_{l,a}+i_{l,c});i_{l,a}=limiting anode current; i_{l,c}=limiting cathode current.

The measured SOC of the different solutions is given in the graph below. After a first measurement at t0, each solution is stored in a hermetically sealed flask for 7 days. A second SOC test at t+7 days is then performed: if the SOC has decreased this means that part of the ferricyanide is reduced to ferrocyanide, which indicates oxidation of the solubilising base.

The following bases were tested: KOH, LiOH, CsOH, RbOH, guanidine, 1,1,3,3-tetramethyl guanidine, proline, NME₄OH, nBu₄OH, CholineOH, Trimethyl-benzyl ammonium OH and PBu₄OH.

The experiment evidenced that all the bases showed no variation in SOC after 7 days, therefore no reducing of ferricyanide to ferrocyanide, with the exception of proline and cholineOH. For these two compounds, the SOC after a contact time of 7 days with a solution of 0.5 mol/L of ferricyanide, was 77.7% and 82.7%, respectively. It therefore appears that bases of secondary amine type and those having an alkyl chain with terminal OH are not as compatible with ferricyanide.

### Example 7: Performance of Batteries of the Invention and Comparison with Comparative Batteries

The following two batteries N°1 and N°2 were prepared: Battery N°1:

TABLE 6

| | |
|---|---|
| Composition of the negolyte | Composition of the posolyte |

Battery No1 (comparative)

| | |
|---|---|
| Concentration: [Alizarin] = 0.1 mol · L⁻¹ | Concentration [Fe(CN)₆, K₄] = 0.2 mol · L⁻¹ |
| Volume of solution: V = 25 mL | Volume of solution: V = 25 mL |
| Strong base: [K⁺, OH⁻] = 0.4 mol · L⁻¹ | Strong base: [K⁺, OH⁻] = 0.2 mol · L⁻¹ |
| Initial pH = 13.4 | Initial pH = 13.3. |

Battery No2

| | |
|---|---|
| Concentration [Alizarin] = 0.46 mol · L⁻¹ | Concentration [Fe(CN)₆, Cs₄] = 0.4 mol · L⁻¹ |
| Volume of solution = 25 mL | Volume of solution = 60 mL |
| Strong base: [Cs⁺, OH⁻] = 1.2 mol · L⁻¹ | Strong base: [Cs⁺, OH⁻] = 0.2 mol · L⁻¹ |
| Initial pH = 13.6 | Initial pH = 13.5 |

### Operating Characteristics

Battery N°1
Theoretical maximum capacity=134 mA.h
Densities of applied current=40 mA/cm² up to cycle 8 then 20 mA/cm²
Maximum charging potential difference: 1.3 V
Minimum discharging potential difference: 0.3 V

### Battery N°2

Theoretical maximum capacity: 616 mA.h
Current densities: 20 mA/cm² (charge), 40 mA/cm² (discharge)
Maximum charging potential difference=1.3 V
Minimum discharging potential difference=0.3 V

### Results of Charge and Discharge Cycles of Batteries N°1 and N°2

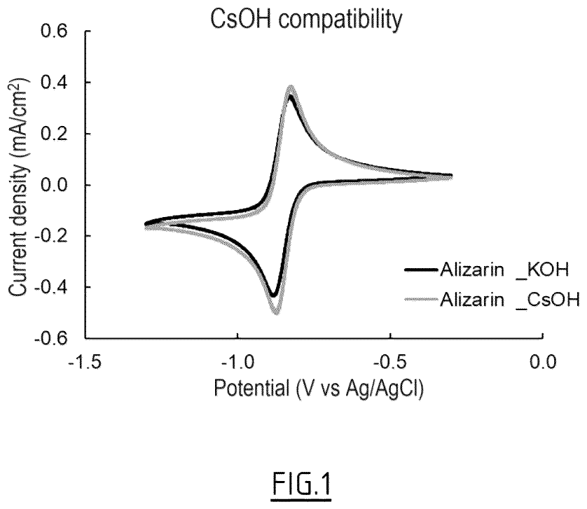

As shown in FIG. 1, the electrochemical signature in cyclic voltammetry of the two cationic environments shows a similar curve. Also, calculation of the apparent rate constants of electron transfer in the two media leads to two very close values.

In KOH solution=0.1 mol·L 1 the rate constant k°=3.9×10⁻³ cm·s⁻¹
In CsOH solution=0.1 mol·L 1 the rate constant k°=3.4×10⁻³ cm·s⁻¹.
This analysis evidences that the presence of CsOH as solubilising base has little impact on the electrochemical behaviour of alizarin, compared with the presence of KOH.

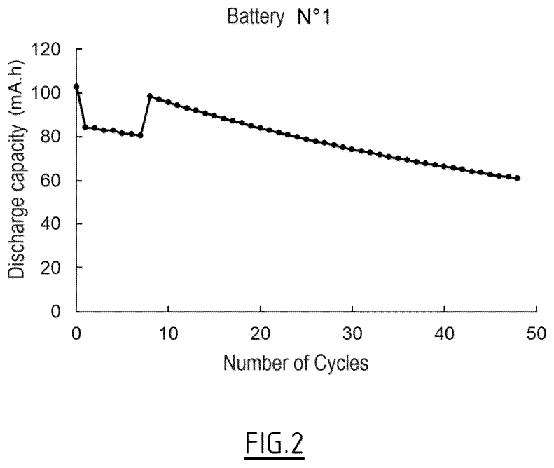

On the other hand, as shown in FIG. 2, the capacity of the battery drops significantly in the region of 1% per charge/discharge cycle. This phenomenon together with low initial capacity cancels out the use of alizarin under these experimental conditions for long-period battery operation.

The drop in capacity can be attributed to two major causes which regularly occur with these types of molecules derived from the anthraquinone family:
1-) Chemical decomposition of the molecule to oxidized or reduced form over time.
2-) Slow precipitation of the molecule.

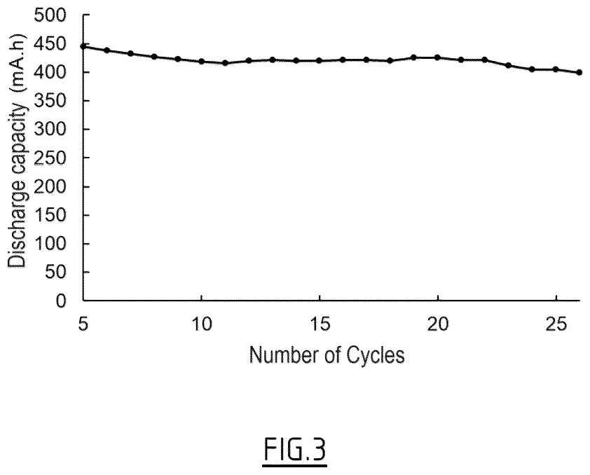

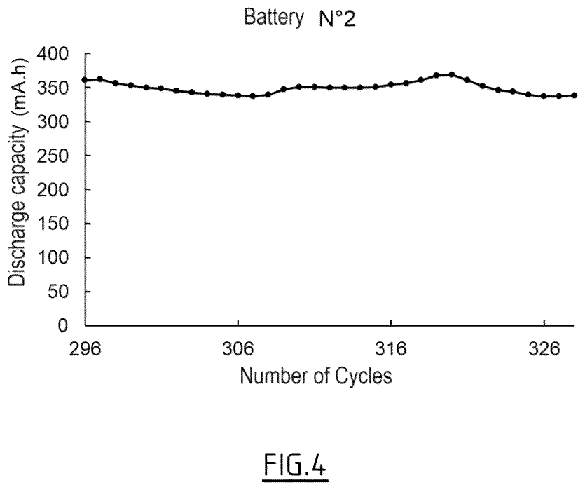

On the contrary, the difference in behaviour of alizarin in the presence of CsOH (FIGS. 3 and 4, compared with FIG. 2) is spectacular, since the presence of CsOH allows solving of the two aforementioned problems. In addition to the strong capacity obtained by means of the solubilising effect, it is the very good stability of the charge and discharge cycles obtained over and above 25 cycles which is remarkable. UV-visible analyses of the oxidized form (at the start of charge) and reduced form (at end of charge) show identical spectra and confirm the chemical stability of alizarin.

To conclude, through the addition of CsOH as solubilising base, the performance of the battery is largely improved.

Two other batteries N°3 and N°4 were also prepared.

TABLE 7

| | |
|---|---|
| Composition of the negolyte | Composition of the posolyte |

Battery No3

| | |
|---|---|
| [Quinizarin] = 0.058 mol · L⁻¹ | [Fe(CN)₆, K₄] = 0.2 mol · L⁻¹ |
| Volume of solution = 25 mL | Volume of solution = 25 mL |
| Strong base: [K⁺, OH⁻] = 0.26 mol · L⁻¹ | Strong base: [K⁺, OH⁻] = 0.2 mol · L⁻¹ |
| Initial pH = 13.4 | Initial pH = 13.3 |

Battery No4

| | |
|---|---|
| Concentration [Quinizarin]= 0.2 mol · L⁻¹ | [Fe(CN)₆, (NMe₄)₄] = 0.076 mol · L⁻¹ |
| [NMe₄⁺, OH⁻] = 0.5 mol · L⁻¹ | [NMe₄⁺, OH⁻] = 0.1 mol · L⁻¹ |
| Volume of solution = 25 mL | Volume of solution = 100 mL |
| Initial pH = 13.2 | Inital pH = 12.8 |

### Operating Characteristics

Batterie N°3
Theoretical maximum capacity: 78 mA.h
Current densities: 40 mA/cm² up to cycle N°120, then 20 mA/cm².
Maximum charging potential difference=1.3 V
Minimum discharging potential difference=0.3 V
Battery N°4
Theoretical maximum capacity: 204 mA.h
Current densities: 20 mA/cm².
Maximum charging potential difference=1.3 V
Minimum discharging potential difference=0.3 V

### Results of Charge and Discharge Cycles of Batteries N°3 and N°4

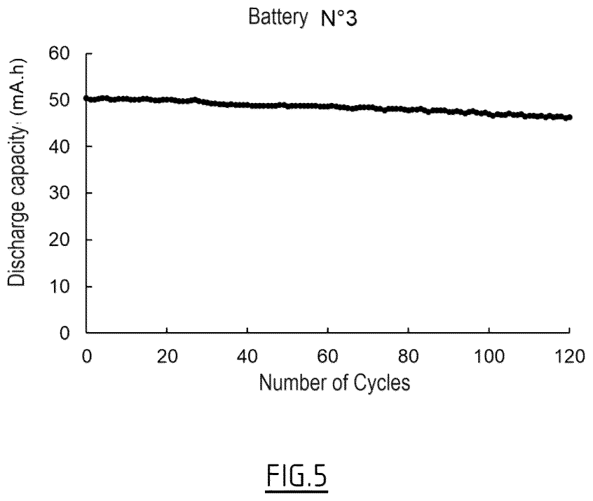

As shown in FIG. 5, the capacity of battery N°3 drops by 0.071% per charge/discharge cycle over the first 100 cycles.

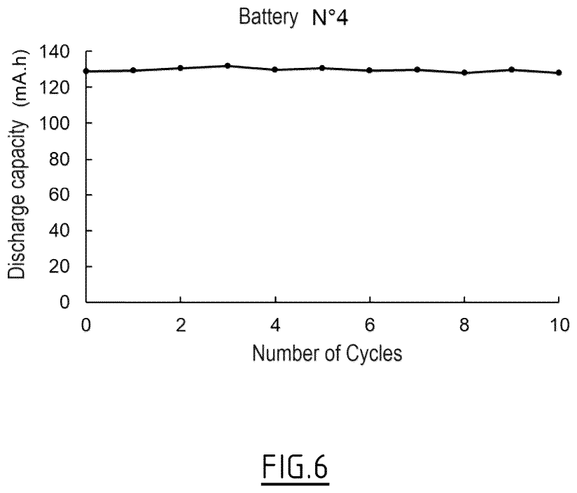

The loss of capacity of battery N°4, seen in FIG. 6, is 0.065% per cycle.

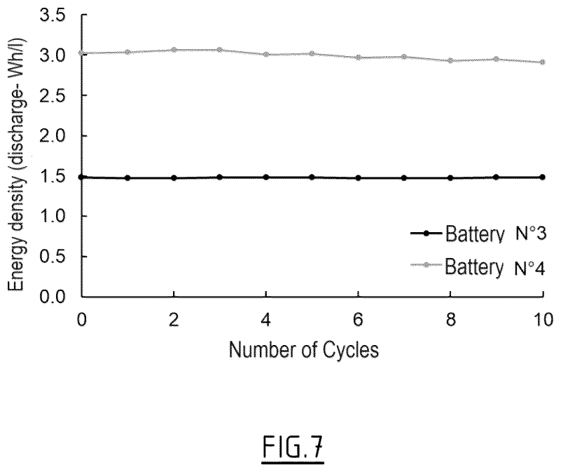

By comparing the performance of batteries N°3 and 4 (see FIGS. 5 and 6), it is observed first that the accessible capacity of battery N°4 is more than 2.5. times greater than that of battery N°3, and secondly that the energy density (see FIG. 7) has increased twofold through the significant increase in the solubility of quinizarin.

These tests therefore demonstrate the efficacy of the solubility-enhancing effect of which the major outcome is a spectacular increase in the capacity of the battery.

### Example 8: Enhancing of the Solubility of Formula (I) Compounds Through the Presence of a Solubilising Base in Combination with a Secondary Base

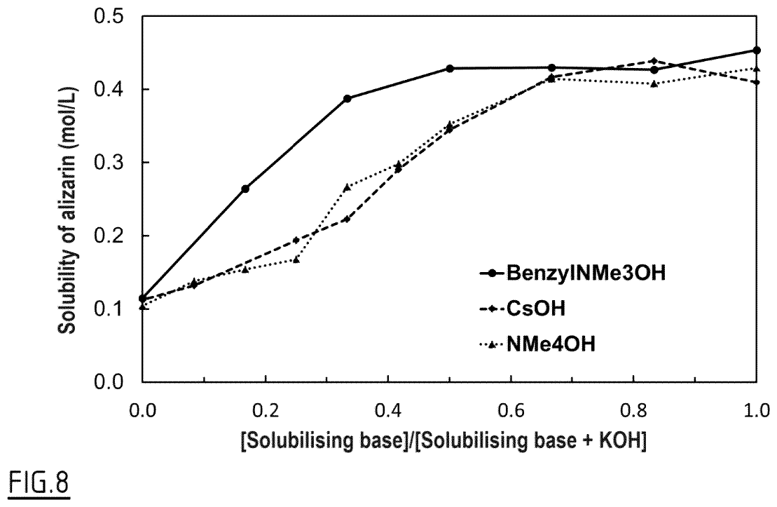

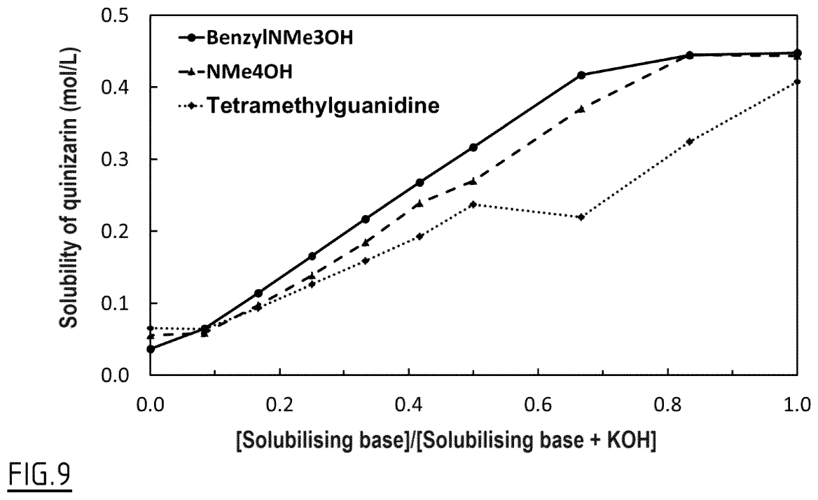

The impact of the presence of a secondary base in the negolyte, in addition to the solubilising base, on the solubility of the formula (I) compounds was evaluated. The solubility of formula (I) compounds in the presence of mixtures of Trimethyl benzyl ammonium/KOH, CsOH/KOH or NMe4OH/KOH at different ratios Rc was determined. Rc represents the molar ratio between the molar concentration of solubilising base and the sum of the molar concentration of solubilising base and molar concentration of secondary base. The results are given in the graphs in FIGS. 8 and 9.

These results show that the addition of a certain quantity of secondary base allows a significant increase in the conductivity of the negolyte, whilst maintaining suitable solubility of the formula (I) compound.

1. A redox flow battery comprising:
a first compartment comprising a negolyte in the form of an aqueous composition comprising at least one compound of formula (I) 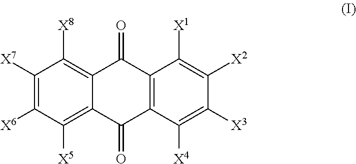
and/or a salt of the compound of formula (I),
and/or a reduced form of the compound of formula (I),
wherein X¹, X², X³, X⁴, X⁵, X⁶, X⁷ and X⁸ are independently selected from the group consisting of a hydrogen atom, a halogen, an ether group of formula —O-A, an OH group, COOH group, a -A-COOH group, a —O-A-COOH group and a linear, cyclic or branched, saturated or unsaturated hydrocarbon group comprising 1 to 10 carbon atoms,
wherein at least one of X¹, X², X³, X⁴, X⁵, X⁶, X⁷ and X⁸ comprises a OH function, a COOH function or a A-COOH group,
a second compartment comprising a posolyte, in the form of an aqueous composition, comprising at least one electroactive molecule,
the negolyte additionally comprising at least one solubilising base, the solubilising base being characterised in that the pKa of the conjugate acid of the solubilising base is higher than 9.5 in water at 25° C. and in that the volume of the cation of the solubilising base is between 14 and 650 cubic Angstroms.

2. The redox flow battery according to claim 1, wherein the solubilising base is selected from the group consisting of caesium or rubidium hydroxides, caesium or rubidium hydrogen carbonates, caesium or rubidium carbonates, and organic bases having a molar mass between 58 and 400 grams per mole, the organic base not comprising an OH group at terminal position.

3. The redox flow battery according to claim 1, wherein the solubilising base is selected from the group consisting of:
caesium or rubidium hydroxides,
caesium or rubidium hydrogenocarbonates,
caesium or rubidium carbonates,
hydroxides of quaternary phosphoniums [R₁R₂R₃R₄P]⁺OH⁻,
wherein R₁, R₂, R₃ and R₄, are independently selected from the group consisting of the phenyl group, —(CH₂)ₙ-Ph phenylalkyls with n being an integer of 1 to 5, and linear, branched or cyclic C1-C16, alkyl chains, optionally interrupted by at least one heteroatom selected from the group consisting of N, O and S, but not comprising an OH group at terminal position,
hydroxides of quaternary ammoniums [R₅R₆R₇R₈N]⁺OH⁻,
wherein:
either R₅, R₆, R₇ and R₈ are independently selected from the group consisting of the phenyl group, —(CH₂)ₙ-Ph phenylalkyls with n being an integer of 1 to 5, and linear, branched or cyclic C1-C16 alkyl chains, optionally interrupted by at least one heteroatom selected from the group consisting of N, O and S, but not comprising an OH group at terminal position;
or R₅ is selected from the group consisting of linear branched or cyclic C4-C20 alkyl chains, optionally interrupted by at least one heteroatom selected from the group consisting of N, O and S, but not comprising an OH group at terminal position, and R₆, R₇ and R₈ are independently selected from the group consisting of linear or branched C1-C3, alkyl chains, optionally interrupted by at least one heteroatom selected from the group consisting of N, O and S, but not comprising an OH group at terminal position,
or R₅ and R₆ are selected from the group consisting of linear, branched or cyclic C4-C20 alkyl chains, optionally interrupted by at least one heteroatom selected from the group consisting of N, O and S, but not comprising an OH group at terminal position, and R₇ and R₈ are independently selected from the group consisting of linear or branched C1-C3 alkyl chains, optionally interrupted by at least one heteroatom selected from the group consisting of N, O and S, but not comprising an OH group at terminal position;
or R₅ and R₆ form a saturated alkyl ring having 4 to 6 carbon atoms, and R₇ and R₈ are selected from the group consisting of linear or branched C1-C6 alkyl chains, optionally interrupted by at least one heteroatom selected from the group consisting of N, O and S, but not comprising an OH group at terminal position;
or R₅, R₆ and R₇ form an aromatic ring having 5 carbon atoms, and R₈ is selected from the group consisting of linear or branched C1-C6 alkyl chains, optionally interrupted by at least one heteroatom selected from the group consisting of N, O and S, but not comprising an OH group at terminal position;
tertiary amines [R₉R₁₀R₁₁N],
wherein either R₉, R₁₀ and R₁ are independently selected from the group consisting of linear, branched, or cyclic C1-C8 alkyl chains, optionally interrupted by at least one heteroatom selected from the group consisting of N, O and S, but not comprising an OH group at terminal position;
or R₉ and R₁₀ form a saturated alkyl ring having 4 to 6 atoms, and R₁₁ is selected from the group consisting of linear or branched C1-C8 alkyl chains, optionally interrupted by at least one heteroatom selected from the group consisting of N, O and S, but not comprising an OH group at terminal position;
amidines [RₐR_{b}NC(R_{c})═NR_{d}]
wherein either Rₐ, R_{b}, R_{c} and R_{d}, are independently selected from the group consisting of linear branched or cyclic C1-C8 alkyl chains, optionally interrupted by at least one heteroatom selected from the group consisting of N, O and S, but not comprising an OH group at terminal position;
or Rₐ and R_{d} form a saturated alkyl ring having 2 to 4 carbon atoms, and Rb and R_{c} form a saturated alkyl ring having 3 to 5 carbon atoms, each ring optionally being substituted by a linear or branched C1-C8 alkyl group;
guanidines [RₑR_{f}NC(NR_{g}Rₕ)═NH]
wherein Rₑ, R_{f}, R_{g} and Rₕ, are independently selected from the group consisting of linear, branched or cyclic C1-C8 alkyl chains, optionally interrupted by at least one heteroatom selected from the group consisting of N, O and S, but not comprising an OH group at terminal position.

4. The redox flow battery according to claim 1, wherein the solubilising base is selected from the group consisting of CsOH, RbOH, trimethylamine, triethylamine, ethyldimethylamine, methyldiethylamine, N-methylpyrrolidine, N-ethylpyrrolidine, N-methylpiperidine, N-ethylpiperidine, 1,8-diazabicyclo[5.4.0]undec-7-ene, 1,1,3,3-tetramethylguanidine, tetramethylammonium hydroxide, tetraethylammonium hydroxide, tetrapropylammonium hydroxide, tetrabutylammonium hydroxide, trimethyl benzylammonium hydroxide, trimethyl cetylammonium hydroxide, didodecyldimethylammonium hydroxide, trimethyl phenylammonium hydroxide, N-methylpyridinium hydroxide, N,N-dimethylpyrrolidinium hydroxide, N,N-dimethylpiperidinium hydroxide and tetrabutylphosphonium hydroxide.

5. The redox flow battery according to claim 1, wherein the solubilising base is selected from the group consisting of CsOH, RbOH, trimethylamine, triethylamine, N-methylpyrrolidine, 1,1,3,3-tetramethylguanidine, tetramethylammonium hydroxide, tetrabutylammonium hydroxide, trimethyl benzylammonium hydroxide and tetrabutylphosphonium hydroxide.

6. The redox flow battery according to claim 1, wherein the solubilising base has a molar concentration in the negolyte of between 0.1 mol/L and 5.0 mol/L.

7. The redox flow battery according to claim 1, wherein the negolyte additionally comprises a secondary base selected from the group consisting of potassium hydroxide, sodium hydroxide, lithium hydroxide, ammonium hydroxide.

8. The redox flow battery according to claim 7, wherein the secondary base has a molar concentration in the negolyte of between 0.01 mol/L and 5.0 mol/L.

9. The redox flow battery according to claim 7 wherein in the negolyte the ratio between [M_{solub,nego}] and [M′_{second,nego}] is higher than or equal to 0.1, [M_{solub,nego}] corresponding to the molar concentration in the negolyte of solubilising base cations and [M_{′second,nego}] corresponding to the molar concentration in the negolyte of secondary base cations.

10. The redox flow battery according to claim 1, wherein the posolyte comprises at least one base selected from the group consisting of the solubilising bases and the secondary bases.

11. The redox flow battery according to claim 10, wherein the base has a molar concentration in the posolyte of between 0.01 mol/L and 1.00 mol/L.

12. The redox flow battery according to claim 1, wherein X¹, X², X³, X⁴, X⁵, X⁶, X⁷ and X⁸ of the compound of formula (I) are independently selected from the group consisting of a hydrogen atom, an OH group, a COOH group, a (CH₂)ₙ—COOH group where n is an integer varying from 1 to 10, and a saturated or unsaturated, linear cyclic or branched hydrocarbon group having 1 to 10 carbon atoms.

13. The redox flow battery according to claim 1, wherein the negolyte and/or the posolyte are free of Cl⁻ and Br⁻ ions.

14. The redox flow battery according to claim 1, wherein it additionally comprises a membrane, said membrane comprising a material selected from the group consisting of fluorinated (co)polymers, (co)poly(ether ketone)s, (co)poly(ether sulfone)s, (co)poly(ether-ether-ketone)s, sulfonated (co)poly(ether-ether-ketone)s, (co)polymers of benzimidazole and (co)polymers of arylene.

15. A method of producing electricity by at least one redox flow battery, wherein the redox flow battery is defined according to claim 1.
